(19) United States
(12) Patent Application Publication
(10) Pub. No.: US 2023/0118129 A1
(43) Pub. Date: Apr. 20, 2023

(54) System of analysis of video stream in order to determine pool water quality and robot presence

(71) Applicant: Deep Innovations Ltd, London (GB)

(72) Inventor: Samuel Weitzman, London (GB)

(21) Appl. No.: 17/966,082

(22) Filed: Oct. 14, 2022

Related U.S. Application Data
(60) Provisional application No. 63/256,691, filed on Oct. 18, 2021.

(51) Int. Cl. G06T 7/40; G06T 7/00; G06V 10/764; E04H 4/16

(52) U.S. Cl. CPC G06T 7/40; G06T 7/0002; G06V 10/764; E04H 4/1654; G06T 2207/10016; G06T 2207/10024; G06T 2207/20081

(57) ABSTRACT

A method of analysis of a stream of screenshots in order to determine pool water quality and robot presence, wherein software analytics compares color or clarity of water in order to figure out if the pool has dirty pool water. The software analytics checks the acceptable boundary regarding water clarity, wherein dirty water will typically go cloudy and/or have a taint of green, and the software analytics determines that higher levels of green in the water indicates worse water quality. The software analytics utilizes machine learning, neural networks and artificial intelligence by being trained on high numbers of screenshots of pools in order to make an accurate determination as to water clarity, a taint of green in water, and cloudiness in water.

### FIELD OF THE INVENTION

The present invention relates to the analysis of video stream of pool water in order to determine the quality of the water.

### BACKGROUND

Today, people have a difficult time maintaining their pools. Indeed because of the pandemic, people might be away from their main home for several months out of the year. This can lead to deterioration of the pool water. This can cause permanent damage to a pool, or necessitate draining an entire pool, and so it would be better to avoid deterioration of water quality.

Furthermore, also because of the pandemic, people might want a higher level of cleanliness in their pool so as to avoid potential infection or other diseases.

Water clarity is currently tested by human beings who use their eyes in order to do a visual inspection of the pool. As such, different people may make different conclusions about water quality. Also, if someone doesn't have perfect vision and needs to inspect a pool, they won't be able to do so. In addition, the ability to qualify if a pool is dirty or not, depends on the interval between inspections and can change gradually over time. As such, if the person inspecting the pool does not inspect the pool between the same interval of time each time, their analysis could be wrong.

### SUMMARY

The present invention solves these issues, because the present invention provides a stream of video of a pool that is analyzed by artificial intelligence. When the video stream arrives at servers, software performs analytics on each single frame from the video stream. The analytics can be done at predetermined intervals.

The analytics compares color or clarity of water in order to figure out if the pool has dirty pool water. If the pool is not treated, it gets greener and greener. If the analytics identifies that the pool is green, then we extend a notification to the user, and inform the user that their pool is dirty.

In addition, performing an analysis for checking water clarity using a video camera is technically challenging. The present invention automates this process, as well as makes the process scalable, such that long periods of time and lots of pools can be analyzed. Part of the reason for this improvement is the use of artificial intelligence, including machine learning, neural networks and deep learning.

### BRIEF DESCRIPTION OF THE DRAWINGS

Many aspects of the present disclosure can be better understood with reference to the attached drawings. The components in the drawings are not necessarily drawn to scale, with emphasis instead being placed upon clearly illustrating the principles of the disclosure. Moreover, in the drawings, like reference numerals designate corresponding parts throughout several views.

FIG. 1 is a drawing of a pool with clean water according to various embodiments of the present disclosure.

FIG. 2 is a drawing of a pool with clean water according to various embodiments of the present disclosure.

FIG. 3 is a drawing of a pool with dirty water according to various embodiments of the present disclosure.

FIG. 4 is a drawing of a pool with dirty water according to various embodiments of the present disclosure.

FIG. 5 is a drawing of a step by step diagram of how the analytics works according to various embodiments of the present disclosure.

FIG. 6 is a drawing of a type of robot that the analytics can look for, according to various embodiments of the present disclosure.

FIG. 7 is also a drawing of a type of robot that the analytics can look for, according to various embodiments of the present disclosure.

### DETAILED DESCRIPTION

Various embodiments of the present disclosure relate to providing an analysis of video stream of pool water in order to determine the quality of the water.

The present invention solves these issues, because the present invention provides a stream of video that is analyzed by artificial intelligence. When the video stream arrives at servers, software performs analytics on each single frame from the video stream. The analytics can be done at predetermined intervals.

In one embodiment of the invention, the analytics compares color or clarity of water in order to figure out if the pool has dirty pool water. If the pool is not treated, it gets greener and greener. If the analytics identifies that the pool is green, then we extend a notification to the user, and inform the user that their pool is dirty.

The software analytics compares color around different parts of the pool in different frames of the video stream. The software analytics also utilizes complexity around how to detect differences in color. In a pool, there are changes in color over time, and so the video stream tracking over a prolonged period of time, check when color moves out of acceptable boundary that are acceptable. The acceptable boundary relates to water clarity, wherein dirty water will typically go cloudy and/or have a taint of green. The more green the water, the worse the water quality.

Another feature of the invention is identifying other anomalies or changes in pool area for other purposes, specifically, the video stream analytics uses artificial intelligence to detect specific types of robots. One example of the kind of robots detected is pool cleaning robots. If the user has a robot periodically checking the pool area then that information can be noted. That information can be utilized to offer a pool cleaning robot to the user, especially if the analytics notices the user doesn't have a robot.

The robots are identified differentiated against anything else through the use of deep learning models to train a neural network to identify robotic pool cleaners. This process consists of gathering multiple images of robotic pool cleaners and training a neural network to identify the robotic pool cleaners, based on probability, in a static image. Alternatively, machine learning or deep learning can be trained to identify the robotic pool cleaners.

Also, by using images from the video stream, checking the video stream for parameters for certain objects using artificial intelligence to identify objects of interest, both in the pool and the backyard area, the analytics is looking for particular objects that are of interests over prolonged period of time. Different prolonged periods of time are once a week, 10-15 weeks, or even 1 year. The analytics can check different amounts of images depending on how often the screenshots occur, such as 10-15 images, or 100-150 images, or 1000-1500 images. The analytics can then definitely conclude whether the user does or does not have a robot

The more images analyzed from the video stream, the better analysis the software analytics can perform. Also, the longer duration of observation, the more accurate the analysis of the software analytics.

Furthermore, by notifying the user as soon as a problem is identified, the user can take steps to have the pool water cleaned immediately. This prevents any worsening of pool water problems. It also allows the user to leave their home for months at a time, because they will be immediately able to solve problems remotely from wherever in the world they are.

In another embodiment of the invention, relevant images from the video stream can be sent directly to the user, in case the user would prefer to make their own determination as to water quality.

In another embodiment of the invention, both images and the analytics analysis can be sent to the user, so that the user can look at the analytics and make their own decision as to whether to get the pool water cleaned.

In another embodiment, the identification of robots can be done by looking for more straight edges, because there are no straight edges in nature, so an object with straight edges would be more likely to be artificial. This analysis would exclude the walls of the pool. Another analysis would be to see how the straight edged object moves, and if it moves in a somewhat straight line, that would also be a further indication that the object is a robot.

In another embodiment of the invention, multiple video streams can be combined and a different analysis is performed vs the analysis of just 1 video stream. This analysis is done by comparing a number of snapshots, and not a full video based analysis.

In another embodiment of the invention, the intervals to capture a frame for analysis can vary by time. For example, one interval can be 1 hour, and another interval can be a half hour. Intervals can be set by the user for any time period. Multiple images are captured over a 24 hour period.

In regards to the complexity around how the analytics detects differences in color and understands changes in color over time, the camera takes images of the backyard and identifies the pool area only (the complex part). Then the analytics tracks the color changes over time, and determines whether those color changes indicate a change in cleanliness for better or worse.

Regarding tracking over a prolonged period of time, changes are significant that can be seen after 24 hrs, however, changes after 48-72 hrs reveal more detail as to the changes in the pool water quality. The analytics can analyze over 1000 images, and there is no maximum number of images the analytics can analyze. The analytics improves with more images, in the sense that the analytics learns what is important and what is important, and so can more accurately identify dirty water versus clean water. The frequency of how often the images are analyzed is configurable.

There is no specific part of the pool that is more useful to look at than other parts of the pool. Similarly, there is no specific angle that is more useful to look at than other angles of the pool. The analytics can take the average mean of the pool to focus in on a specific area of the pool if the invention determines that analyzing that specific area will be useful, as in the analytics suspects that that specific area might be changing for the worse in terms of water quality. Such a suspicion might be raised by the user, or by an artificial intelligence analysis.

The analytics can use multiple types of artificial intelligence in order to identify dirty water or particular robots, including machine learning, deep learning, and neural networks.

It is not necessary for multiple cameras to view a pool, because all the snapshots from the camera should be analyzed from the same camera. It is possible to have more than one camera viewing the same pool, but snapshots must be unique to each camera in terms of the analysis conducted by the invention's analytics.

In another embodiment of the invention, software analytics compares color or clarity of water in order to figure out if the pool has dirty pool water. The software analytics compares color around different parts of the pool in different screenshots from a camera. The software analytics also utilizes complexity around how to detect differences in color. In a pool, there are changes in color over time, and so the screenshots taken over a prolonged period of time are checked to see when color moves out of an acceptable boundary. The acceptable boundary relates to water clarity, wherein dirty water will typically go cloudy and/or have a taint of green. The more green the water, the worse the water quality. The software analytics also uses artificial intelligence to detect specific types of robots. One example of the kind of robots detected is pool cleaning robots. If the user has a robot periodically checking the pool area then that information can be noted. That information can be utilized to offer a pool cleaning robot to the user, especially if the analytics notices the user doesn't have a robot. The more screenshots analyzed, the better analysis the software analytics can perform. Also, the longer duration of observation, the more accurate the analysis of the software analytics. Similarly, the more cameras used, the more accurate the analysis of the software analytics. The typical interval between screenshots is 1 hour, but this interval can be changed by the user. Furthermore, relevant screenshots and a summary of the analytics can be electronically sent directly to the user.

The software analytics also analyzes uses different techniques to detect bad quality water. In addition to comparing the water color, the software analytics also benchmark each image based on time of day and over multiple days, so that external factors such as cloud coverage, leaves in the pool, and other irrelevant items do not disturb the software analytics' automated analysis. The software analytics also compares pool segmentation in order to make sure we are comparing apples to apples. Pool Segmentation is where the software analytics sends each image of the pool from 1 camera to a new neural network that returns an outline of a water line of the pool. This outline is compared to images from the same camera in order to make sure the camera has not shifted or been moved.

In another embodiment of the invention, the software analytics uses machine learning. In addition to comparing the water color, the software analytics also benchmark each image based on time of day and over multiple days, so that external factors such as cloud coverage, leaves in the pool, and other irrelevant items do not disturb the software analytics' automated analysis. This benchmarking of images can then be analyzed using either machine learning, neural networks, deep learning or artificial intelligence. The software analytics also compares pool segmentation in order to make sure we are comparing apples to apples. Another version of pool segmentation is where the software analytics sends each image of the pool from 1 camera to the software analytics, which uses either machine learning, deep learning or artificial intelligence, and then returns an outline of a water line of the pool. This outline is compared to images from the same camera in order to make sure the camera has not shifted or been moved.

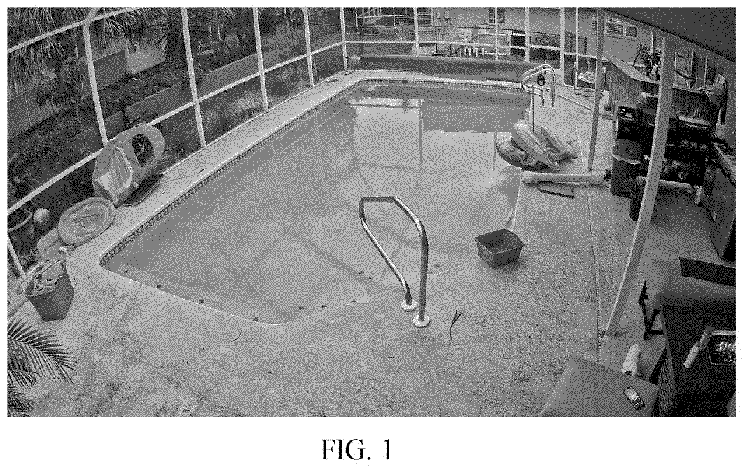

FIG. 1 is one embodiment of the invention, showing a pool with clean water. The pool is clean and blue in color. There are also some plastic items both near the pool, as well as hanging above the pool.

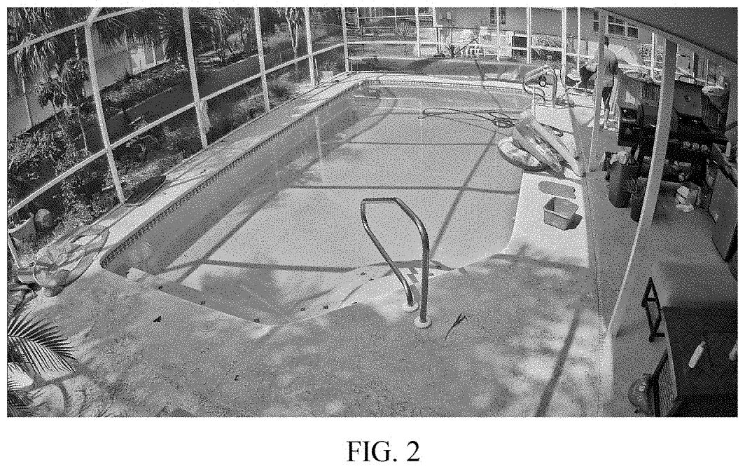

FIG. 2 is one embodiment of the invention, showing a pool with clean water. The pool is clean and blue in color, and also displays some shadows. There are also some plastic items both near the pool, as well as hanging above the pool.

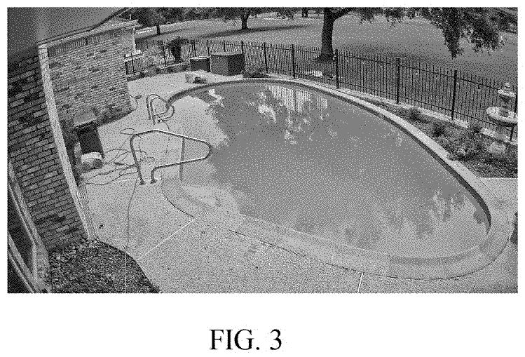

FIG. 3 is one embodiment of the invention, showing a pool with dirty water. The pool color has turned a shade of green.

In one embodiment of the invention, the pixel of the lightest shade of green shown in the pool in FIG. 3 is the boundary limit for the software analytics to determine that a pool has been tainted green. If the software analytics noticed a pixel of that lightest shade of green in a screenshot from a camera monitoring a pool, then the software analytics would conclude that the pool has dirty water. The software analytics might then inform both a pool cleaner and the owner of the pool so that they could either clean the pool or resolve the issue in another way.

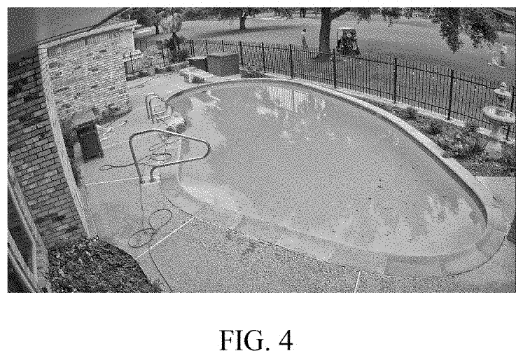

FIG. 4 is one embodiment of the invention, showing a pool with dirty water. There are some leaves and debris in the pool.

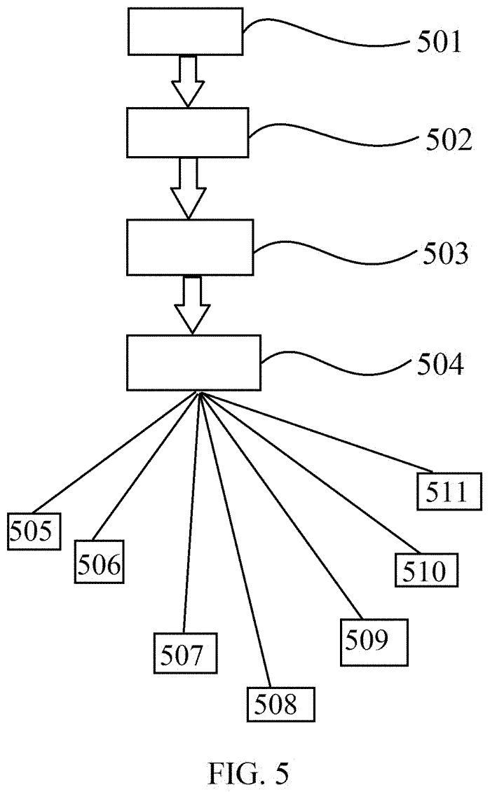

FIG. 5 is one embodiment of the invention, showing a step by step diagram of how the analytics works.

Step 501 is when software analytics compares color or clarity of water in order to figure out if the pool has dirty pool water. Step 502 is when the software analytics compares color around different parts of the pool in different screenshots from a camera. Step 503 is when the software analytics also utilizes complexity around how to detect differences in color, such that the screenshots taken over a prolonged period of time are checked to see when color moves out of an acceptable boundary. Step 504 is when the acceptable boundary relates to water clarity, wherein dirty water will typically go cloudy and/or have a taint of green, and the software analytics determines that higher levels of green in the water indicates worse water quality. Furthermore, the software analytics utilizes a neural network by being trained on high numbers of screenshots of pools in order to make an accurate determination as to water clarity, a taint of green in water, and cloudiness in water.

Steps 505 through 511 are optional after step 504. Step 505 is when the software analytics also uses artificial intelligence to detect specific types of robots; and wherein one type of robot detected is pool cleaning robots. Step 506 is when higher numbers of screenshots analyzed results in better analysis by the software analytics. Step 507 is when longer durations of observation results in more accurate analysis by the software analytics. Step 508 is when more cameras used, the more accurate the analysis of the software analytics. Step 509 is when a typical interval between screenshots is 1 hour, but this interval can be changed by the user. Step 510 is when relevant screenshots and a summary of the analytics by the software analytics can be electronically sent directly to a user. Step 511 is when the more numbers of screenshots that the software analytics analyzed, the better the final analysis by the software analytics; wherein longer durations of observation results in more accurate analysis by the software analytics; wherein more cameras used, the more accurate the analysis of the software analytics; wherein a typical interval between screenshots is 1 hour, but this interval can be changed by the user; and wherein relevant screenshots and a summary of the analytics by the software analytics can be electronically sent directly to a user.

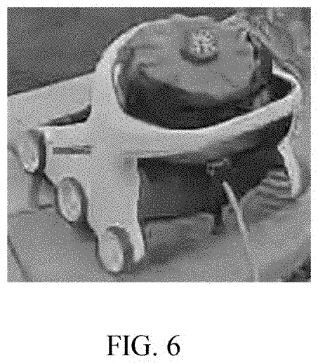

FIG. 6 is one embodiment of the invention, showing a type of robot that the analytics can look for. This robot has 3 wheels and is plugged into an outlet. It has a circular top and is made out of plastic. The software analytics is able to identify this robot as a pool cleaning robot. One of the ways the software analytics can identify this robot is by the shape of the robot.

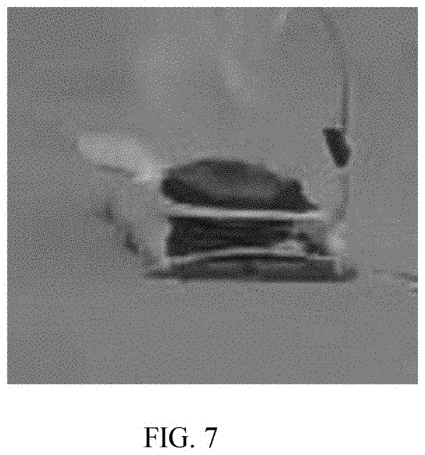

FIG. 7 is one embodiment of the invention, showing another type of robot that the analytics can look for. This robot is underwater, the plug is still connected to an outlet, and the robot is rolling on the floor of the pool. The software analytics is able to identify this robot as a pool cleaning robot. One of the ways the software analytics can identify this robot is by the shape of the robot. Another way the software analytics can identify this robot as a pool cleaning robot is by noticing that the robot is moving on its own underwater.

The following are additional embodiments:

Embodiment 1: A system of analysis of a video stream in order to determine pool water quality and robot presence, wherein software analytics compares color or clarity of water in order to figure out if the pool has dirty pool water; wherein the software analytics compares color around different parts of the pool in different screenshots from a camera; wherein the software analytics also utilizes complexity around how to detect differences in color, such that the screenshots taken over a prolonged period of time are checked to see when color moves out of an acceptable boundary; wherein the acceptable boundary relates to water clarity, wherein dirty water will typically go cloudy and/or have a taint of green, and the software analytics determines that higher levels of green in the water indicates worse water quality; and wherein the software analytics utilizes a neural network by being trained on high numbers of screenshots of pools in order to make an accurate determination as to water clarity, a taint of green in water, and cloudiness in water.

Embodiment 2: The embodiment above, further comprising: wherein the software analytics also uses neural networks to detect specific types of robots; and wherein one type of robot detected is pool cleaning robots.

Embodiment 3: Any combination of the above embodiments, further comprising: wherein higher numbers of screenshots analyzed results in better analysis by the software analytics.

Embodiment 4: Any combination of the above embodiments, further comprising: wherein longer durations of observation results in more accurate analysis by the software analytics.

Embodiment 5: Any combination of the above embodiments, further comprising: wherein more cameras used, the more accurate the analysis of the software analytics.

Embodiment 6: Any combination of the above embodiments, further comprising: wherein a typical interval between screenshots is 1 hour, but this interval can be changed by the user.

Embodiment 7: Any combination of the above embodiments, further comprising: wherein relevant screenshots and a summary of the analytics by the software analytics can be electronically sent directly to a user.

Embodiment 8: Any combination of the above embodiments, further comprising: wherein higher numbers of screenshots analyzed results in better analysis by the software analytics; wherein longer durations of observation results in more accurate analysis by the software analytics; wherein more cameras used, the more accurate the analysis of the software analytics; wherein a typical interval between screenshots is 1 hour, but this interval can be changed by the user; and wherein relevant screenshots and a summary of the analytics by the software analytics can be electronically sent directly to a user.

Embodiment 9: A method of analysis of a video stream in order to determine pool water quality and robot presence, wherein software analytics compares color or clarity of water in order to figure out if the pool has dirty pool water; wherein the software analytics compares color around different parts of the pool in different screenshots from a camera; wherein the software analytics also utilizes complexity around how to detect differences in color, such that the screenshots taken over a prolonged period of time are checked to see when color moves out of an acceptable boundary; wherein the acceptable boundary relates to water clarity, wherein dirty water will typically go cloudy and/or have a taint of green, and the software analytics determines that higher levels of green in the water indicates worse water quality; wherein the software analytics utilizes artificial intelligence by being trained on high numbers of screenshots of pools in order to make an accurate determination as to water clarity, a taint of green in water, and cloudiness in water; wherein higher numbers of screenshots analyzed results in better analysis by the software analytics; wherein longer durations of observation results in more accurate analysis by the software analytics; wherein more cameras used, the more accurate the analysis of the software analytics; wherein a typical interval between screenshots is 1 hour, but this interval can be changed by the user; and wherein relevant screenshots and a summary of the analytics by the software analytics can be electronically sent directly to a user.

Embodiment 10: A method of analysis of a stream of screenshots in order to determine pool water quality and robot presence, wherein software analytics compares color or clarity of water in order to figure out if the pool has dirty pool water; wherein the software analytics compares color around different parts of the pool in different screenshots from a camera; wherein the software analytics also utilizes complexity around how to detect differences in color, such that the screenshots taken over a prolonged period of time are checked to see when color moves out of an acceptable boundary; wherein the acceptable boundary relates to water clarity, wherein dirty water will typically go cloudy and/or have a taint of green, and the software analytics determines that higher levels of green in the water indicates worse water quality; and wherein the software analytics utilizes machine learning by being trained on high numbers of screenshots of pools in order to make an accurate determination as to water clarity, a taint of green in water, and cloudiness in water.

Embodiment 11: Embodiment 10, further comprising: wherein the software analytics also uses machine learning to detect specific types of robots; and wherein one type of robot detected is pool cleaning robots.

Embodiment 12: Any combination of embodiments 10-11, further comprising: wherein higher numbers of screenshots analyzed results in better analysis by the software analytics.

Embodiment 13: Any combination of embodiments 10-12, further comprising: wherein longer durations of observation results in more accurate analysis by the software analytics.

Embodiment 14: Any combination of embodiments 10-13, further comprising: wherein more cameras used, the more accurate the analysis of the software analytics.

Embodiment 15: Any combination of embodiments 10-14, further comprising: wherein a typical interval between screenshots is 1 hour, but this interval can be changed by the user.

Embodiment 16: Any combination of embodiments 10-15, further comprising: wherein relevant screenshots and a summary of the analytics by the software analytics can be electronically sent directly to a user.

Embodiment 17: Any combination of embodiments 10-16, further comprising: wherein higher numbers of screenshots analyzed results in better analysis by the software analytics; wherein longer durations of observation results in more accurate analysis by the software analytics; wherein more cameras used, the more accurate the analysis of the software analytics; wherein a typical interval between screenshots is 1 hour, but this interval can be changed by the user; and wherein relevant screenshots and a summary of the analytics by the software analytics can be electronically sent directly to a user.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus.

A computer storage medium can be, or can be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium also can be, or can be included in, one or more separate physical components or media (e.g., multiple CDs, disks, or other storage devices). The operations described in this specification can be implemented as operations performed by a data processing apparatus on data stored on one or more computer-readable storage devices or received from other sources.

The term “processor” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus also can include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., an LCD (liquid crystal display), LED (light emitting diode), or OLED (organic light emitting diode) monitor, for displaying information to the user and a keyboard and a pointing device, e.g., a mouse or a trackball, by which the user can provide input to the computer. In some implementations, a touch screen can be used to display information and to receive input from a user. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

From the foregoing, it will be appreciated that specific embodiments of the invention have been described herein for purposes of illustration, but that various modifications may be made without deviating from the spirit and scope of the invention. Accordingly, the invention is not limited except as by the appended claims.

1. A system of analysis of a video stream in order to determine pool water quality and robot presence, wherein
software analytics compares color or clarity of water in order to figure out if the pool has dirty pool water;
wherein the software analytics compares color around different parts of the pool in different screenshots from a camera;
wherein the software analytics also utilizes complexity around how to detect differences in color, such that the screenshots taken over a prolonged period of time are checked to see when color moves out of an acceptable boundary;
wherein the acceptable boundary relates to water clarity, wherein dirty water will typically go cloudy and/or have a taint of green, and the software analytics determines that higher levels of green in the water indicates worse water quality; and
wherein the software analytics utilizes a neural network by being trained on high numbers of screenshots of pools in order to make an accurate determination as to water clarity, a taint of green in water, and cloudiness in water.

2. The system of claim 1, further comprising:
wherein the software analytics also uses neural networks to detect specific types of robots; and
wherein one type of robot detected is pool cleaning robots.

3. The system of claim 1, further comprising:
wherein higher numbers of screenshots analyzed results in better analysis by the software analytics.

4. The system of claim 1, further comprising:
wherein longer durations of observation results in more accurate analysis by the software analytics.

5. The system of claim 1, further comprising:
wherein more cameras used, the more accurate the analysis of the software analytics.

6. The system of claim 1, further comprising:
wherein a typical interval between screenshots is 1 hour, but this interval can be changed by the user.

7. The system of claim 1, further comprising:
wherein relevant screenshots and a summary of the analytics by the software analytics can be electronically sent directly to a user.

8. The system of claim 1, further comprising:
wherein higher numbers of screenshots analyzed results in better analysis by the software analytics;
wherein longer durations of observation results in more accurate analysis by the software analytics;
wherein more cameras used, the more accurate the analysis of the software analytics;
wherein a typical interval between screenshots is 1 hour, but this interval can be changed by the user; and
wherein relevant screenshots and a summary of the analytics by the software analytics can be electronically sent directly to a user.

9. A method of analysis of a video stream in order to determine pool water quality and robot presence, wherein
software analytics compares color or clarity of water in order to figure out if the pool has dirty pool water;
wherein the software analytics compares color around different parts of the pool in different screenshots from a camera;
wherein the software analytics also utilizes complexity around how to detect differences in color, such that the screenshots taken over a prolonged period of time are checked to see when color moves out of an acceptable boundary;
wherein the acceptable boundary relates to water clarity, wherein dirty water will typically go cloudy and/or have a taint of green, and the software analytics determines that higher levels of green in the water indicates worse water quality;
wherein the software analytics utilizes artificial intelligence by being trained on high numbers of screenshots of pools in order to make an accurate determination as to water clarity, a taint of green in water, and cloudiness in water;
wherein higher numbers of screenshots analyzed results in better analysis by the software analytics;
wherein longer durations of observation results in more accurate analysis by the software analytics;
wherein more cameras used, the more accurate the analysis of the software analytics;
wherein a typical interval between screenshots is 1 hour, but this interval can be changed by the user; and
wherein relevant screenshots and a summary of the analytics by the software analytics can be electronically sent directly to a user.

10. A method of analysis of a stream of screenshots in order to determine pool water quality and robot presence, wherein
software analytics compares color or clarity of water in order to figure out if the pool has dirty pool water;
wherein the software analytics compares color around different parts of the pool in different screenshots from a camera;
wherein the software analytics also utilizes complexity around how to detect differences in color, such that the screenshots taken over a prolonged period of time are checked to see when color moves out of an acceptable boundary;
wherein the acceptable boundary relates to water clarity, wherein dirty water will typically go cloudy and/or have a taint of green, and the software analytics determines that higher levels of green in the water indicates worse water quality; and
wherein the software analytics utilizes machine learning by being trained on high numbers of screenshots of pools in order to make an accurate determination as to water clarity, a taint of green in water, and cloudiness in water.

11. The method of claim 10, further comprising:
wherein the software analytics also uses machine learning to detect specific types of robots; and
wherein one type of robot detected is pool cleaning robots.

12. The method of claim 10, further comprising:
wherein higher numbers of screenshots analyzed results in better analysis by the software analytics.

13. The method of claim 10, further comprising:
wherein longer durations of observation results in more accurate analysis by the software analytics.

14. The method of claim 10, further comprising:
wherein more cameras used, the more accurate the analysis of the software analytics.

15. The method of claim 10, further comprising:
wherein a typical interval between screenshots is 1 hour, but this interval can be changed by the user.

16. The method of claim 10, further comprising:
wherein relevant screenshots and a summary of the analytics by the software analytics can be electronically sent directly to a user.

17. The method of claim 10, further comprising:
wherein higher numbers of screenshots analyzed results in better analysis by the software analytics;
wherein longer durations of observation results in more accurate analysis by the software analytics;
wherein more cameras used, the more accurate the analysis of the software analytics;
wherein a typical interval between screenshots is 1 hour, but this interval can be changed by the user; and
wherein relevant screenshots and a summary of the analytics by the software analytics can be electronically sent directly to a user.
